(19) United States
(12) Patent Application Publication
(10) Pub. No.: US 2019/0174684 A1
(43) Pub. Date: Jun. 13, 2019

(54) ENVIRONMENTAL MICROCLIMATE GROWTH CHAMBER AND METHOD

(71) Applicant: Ian Spence, Saskatoon (CA)

(72) Inventor: Ian Spence, Saskatoon (CA)

(21) Appl. No.: 16/216,423

(22) Filed: Dec. 11, 2018

Related U.S. Application Data
(60) Provisional application No. 62/597,463, filed on Dec. 12, 2017.

(51) Int. Cl. A01G 9/24; A01G 9/26

(52) U.S. Cl. CPC A01G 9/246; A01G 31/02; A01G 9/26; A01G 9/247

(57) ABSTRACT

System, apparatuses, and methods for growing more than three cannabis plants within a closed, controlled environment chamber, capable of providing each cannabis plant with an individually-uniform environmental microclimate treatment. Single environmental microclimate parameters can then be varied at a controlled rate, unveiling the relationship each variety has with its environment and how that can be optimized to create the best product, the fastest, with the least inputs, in an identically repeatable manner.

### FIELD

This invention is in the field of plant growth chambers, and more specifically to microclimate plant growth chambers for production of both foreign (recombinant proteins) and non-foreign compounds, such as cannabis, opium poppies, tobacco, deadly nightshade, rhubarb, cascara, Alexandian senna, foxglove, lily of the valley, pomegranate, rose, lavender, thyme, etc. More particularly, the microclimate plant growth chambers may be for cannabis growth.

### BACKGROUND

Canadian Pat. App. No. 2,964,416 to Avid Growing Systems Inc. discloses systems, apparatuses, and methods for growing marijuana plants, particularly for regulated purposes. Automated subsystems with sensors provide feedback information about system, apparatus and plant growth parameters to a controller. The controller alters one or more parameters to provide optimal conditions for the growing and harvesting of the marijuana plants. The systems, apparatuses, and methods provide for control of odors produced during the growing of marijuana, root management of the marijuana plants, and control over levels of chemicals provided to the plants, for example enzymes and flavor additives.

### SUMMARY

The present invention may comprise one or more of the aspects in any and all combinations as described herein. For example, according to an aspect, a plant growth chamber may have: a hub; an exterior wall encompassing the hub; a ceiling and a floor extending between the exterior wall and the hub; at least one microclimate between the exterior wall and the hub; and at least one sensor configured to measure at least one parameter from the at least one microclimate or a plant within the at least one microclimate in order to maintain at least one abiotic gradient associated with the at least one microclimate. A controller may execute instructions from a tangible computer-readable medium to control at least one of: a hydroponic system, a lighting system, a nutrient system, and an HVAC system. The controller may execute instructions to maintain the at least one abiotic gradient associated with each of the at least one microclimate based on a measurement data from the at least one sensor.

In some aspects, the at least one microclimate may be equally spaced from adjacent microclimates. The exterior wall may have at least one door for accessing the at least one controlled microclimate.

In some aspects, the hydroponic system may provide moisture to at least one root of the plant and may provide nutrients to the at least one root of the plant. The hydroponic system may have a substrate container; an input line receiving moisture from a treatment pump; and a water treatment controller controlling the treatment pump.

In some aspects, the lighting system may have at least one light associated with each of the at least one microclimate; and each of the at least one light being individually controllable. The at least one light may have a controllable photoperiod with an intensity and a frequency. The at least one light may be located above the at least one microclimate.

In some aspects, the HVAC system may have at least one of: a heater, a fan, a humidifier, a dehumidifier, and an air conditioner for treating air provided to at least one air supply input associated with the at least one microclimate. The HVAC system may direct the treated air to adjust at least one of: an air velocity, an air stream width, and an air stream composition. The HVAC system may have at least one air outtake arranged above each of the at least one microclimates.

In some aspects, the at least one sensor comprises a non-destructive sensor. The non-destructive sensor may be selected from at least one of: at least one air temperature sensor, at least one humidity sensor, at least one pH sensor, at least one electrical conductivity sensor, at least one water temperature sensor, at least one carbon dioxide sensor, at least one water level sensor, and at least one light intensity sensor.

In some aspects, the at least one sensor is at least one camera. The at least one camera may be at least one of: a colour camera, an infrared camera, a fluorescence camera, and a hyperspectral camera.

According to another aspect, a method of growing plants may provide a plurality of plants within an enclosed growth chamber; control at least one microclimate within the enclosed growth chamber to create an individually-uniform environmental microclimate for every plant within the chamber; and automatically recording at least one parameter of the at least one microclimate associated with a morphology of the plurality of plants.

The method may adjust the at least one microclimate; determine at least one optimal parameter for the at least one parameter to produce a response curve for each of the at least one microclimate; and establish suggestions to improve to conditions plants within the enclosed growth chamber.

### DESCRIPTION OF THE DRAWINGS

While the invention is claimed in the concluding portions hereof, example aspects are provided in the accompanying detailed description which may be best understood in conjunction with the accompanying diagrams where like parts in each of the several diagrams are labeled with like numbers, and where:

FIG. 1 depicts a top schematic plan view of a microclimate growth chamber demonstrating light positioning and controller placement for growing plants;

FIG. 2 illustrates a top schematic plan view of one or more HVAC components of the microclimate growth chamber;

FIG. 3 shows a top schematic plan view of a water system of the microclimate growth chamber;

FIG. 4 is a side perspective view of the microclimate chamber depicting a location of the air control units and water control units;

FIG. 5 depicts a side plan view of exterior and interior walls in which the HVAC components and one or more horizontal lights are held for the microclimate growth chamber with sensor placement;

FIG. 6 is a side perspective view of the microclimate chamber depicting an open access panel; and

FIG. 7 is a flowchart of a method of selecting plants using one or more growth chambers.

### DETAILED DESCRIPTION

For plants with medicinal properties, such as described herein cannabis, producers may be required to deliver a consistent supply of precise, accurate, and/or effective product. The product may comprises one or more active ingredients that may be required (e.g. by regulations and/or law) to fall within a potency range. To produce a phenotypically uniform product that lies within a range of desirable characteristics, a phenotype of a plant may be controlled by two parameters, genetics and the abiotic growth environment. Using clonal propagation, the genetics of production populations are homogeneous. Since the production population are homogenous, only environmental factors may affect development of tissue and a composition of the final product. The composition of a plant may only be that of which has been taken from an abiotic environment around the plant. Genomic information dictates how the plant may constitute these abiotic elements within itself, thereby influencing a final composition of the product.

Any unexpected phenotypic results from any individual may be noted and post-harvest “omic” analysis may be compared with an “almost identical” individual (e.g. a mutant) and changes in the genome, metabolites, RNA, or proteins may be measured and compared. Quality assurance among plants may be necessary in order to avoid genetic drift as a result of unknowingly propagating a deleterious mutant.

Growth chambers supporting individually-non-uniform environmental treatment delivery may not be as effective as growth chambers supporting individually-uniform environmental treatment delivery for unveiling a set of specific environmental microclimate parameters necessary for optimizing genotype by environment interactions. A phenotypic response from an environmentally non-uniform environmental treatment delivery cannot control a single environmental microclimate parameter variable throughout a chamber. Therefore, relative orientation and location of the environmental microclimate delivery points 5 and other neighboring plants within a chamber 100 may be adjusted to deliver a homogeneous treatment to the plants as describe in further detail below.

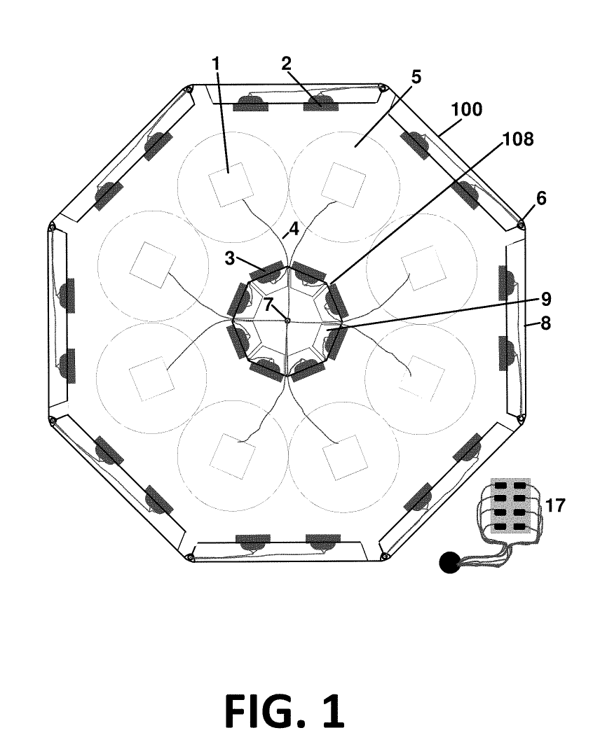

As described with reference to FIGS. 1 to 6, a multi-plant growth chamber 100 may be capable of delivering an individually-uniform treatment environment to more than one plant within the chamber 100. The chamber 100 may permit three or more plants, in this aspect, eight plants, to be grown in individually-uniform environments. Because the chamber 100 may allow for each plant to be grown in an individually-uniform environmental microclimate, an optimized abiotic treatment may be applied to each plant within the chamber 100. The optimized abiotic treatment may maximize a compositional chemical homogeneity within the final product.

Omics methods may allow measurable aspects of a metabolism of each plant to be recorded. Phenotypic information may be collected using non-destructive (e.g. throughout life of plant) and destructive (e.g. during harvest) techniques. Phenotyping methods may use visual, infrared, fluorescence, and/or 3D cameras along with Agriculture Cyber-Physical Systems may allow for automatic data collection of a phenotypic result of each plant population.

Non-Destructive sensors may include: RGB cameras, infrared cameras, fluorescence cameras, and/or hyperspectral cameras. In one aspect, the RGB cameras 18 may comprise one or more lens (not shown), one or more filters (not shown), an image sensor (not shown), and may be read by a processing structure (not shown), such as a control system. The processing structure may comprise a processor, memory, a network, and inputs for receiving sensor data and outputs for controlling growth devices (e.g. such as for example valves, lights, air control units, water control units, etc.) or presenting output to a display for a user. The one or more filters of the RGB cameras 18 may limit the RGB cameras 18 to only detect a visible light spectrum. The RGB cameras 18 may be housed on interior walls 9 and/or exterior walls 8 in order to collect data from around the plant. The RGB cameras 18 may measure various aspects of growth and development of the plant, such as but not limited to shoot/root architecture, morphology, movement/rhythmic behavior, colour, and/or any other visible parameter.

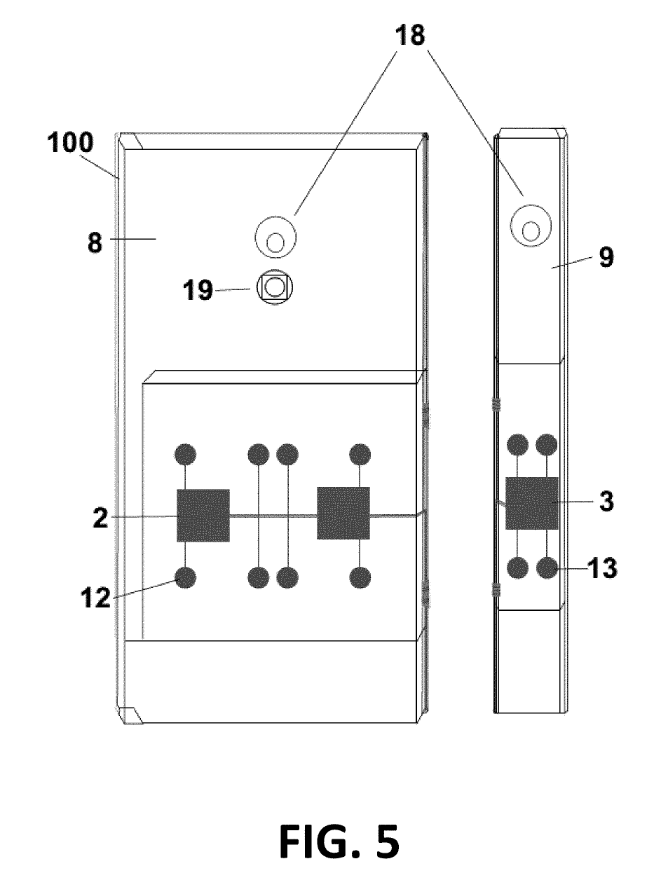

In one aspect, the infrared cameras (also shown as 18 in FIG. 5) may comprise one or more lens (not shown), one or more filters (not shown), an image sensor (not shown), and may be read by a processing structure (not shown). The one or more filters of the infrared cameras 18 may limit the infrared cameras 18 to only detect an infrared light spectrum. The infrared cameras 18 may measure thermal imaging for the collection data of long-wave radiation range of the spectrum which may be emitted in correlation with temperature. Temperature data may provide information of how water transpiration rates and therefore stomatal conductance. In some aspects, the infrared cameras 18 may be encompassed with the RGB camera 18 housed in each of the interior walls 9 and/or exterior walls 8.

In another aspects, a hyperspectral camera 19 may measures a response of each pixel to a series of bands of electromagnetic radiation. Each image from the hyperspectral camera 19 may represent a narrow wavelength range of the electromagnetic spectrum and the images may be combined using the processing structure to form a three-dimensional hyperspectral data cube for processing and analysis. In some aspects, a single hyperspectral camera 19 may observe and record data from multiple chambers 100 in order to reduce expenses. The hyperspectral camera 19 may be used to determine many aspects of plant composition, including cell structure, water content, pigment, chlorophyll, etc.

In another aspects, fluorescence cameras 20 may use pulse modulation to measure photosystem II activity and efficiency in the plants as well as non-photochemical quenching. The florescence cameras 20 may be capable of an early detection method to detect stress within a tissue as one of the first things to change with any response may be photosynthetic activation.

Destructive methods and sensors may include: Metabolomics (e.g. Capillary Electrophoresis Mass Spectrometry), Genomics (e.g. Gene Sequencing), Transcriptomics (e.g. Microarray analysis), and/or Proteomics (e.g. Microscale Thermophoresis).

Non-destructive data may provide additional information when used in reference with destructive data to prescribe specific relationships involved with objective fitness. For example, if post-harvest testing revealed an individual plant within a population expressed a much higher rate of a single desired compound, the non-destructive data collected, specifically in this case from hyperspectral imaging may be used to compare the closest relative without the desired compound present (or only trace amounts of it) to the individual plant in question. The hyperspectral images from each may be superimposed on top of each other by subtracting one from the other leaving a net difference in response. This response may be given a higher fitness value so if further along in the program, an unrelated organism expresses a similar response to that involved in the net response between the individual and its relative, inferences about specific compounds may be made in order to learn more about causal relationships rather than brute testing of every sample. Sampling may be done during early stages to test an efficacy of the intention and/or periodically to maintain calibration. As research progresses, the databank may collection additional growth and aspects of improvement may increase with the amount of data collected.

The chamber 100 may be for delivering environments that unveil the expression of compounds produced by an individual plant by controlling the rate, concentration and stability to which these compounds may be made as is further described below.

Phenotypic image data may be collected throughout the life cycle of the plants from various sensors. This data may be directed to an Integrated Analysis Platform (IAP) where block-based methods may be used to analyze each dataset specifically correlating collected image data with measurable phenotypic traits which may then indexed for fitness and compared across samples. Automated high-throughput image collection using the aforementioned RBG, 3D, Infrared, and/or Fluorescence cameras along with manually collected hyperspectral imaging may be interpreted using the IAP as described below.

Once the plants may be grown to a significant level of compositional homogeneity, controlled variations may be made to a single environmental microclimate treatment parameter along a controlled gradient within the chamber 100. This controlled abiotic gradient may evoke a phenotypic response in the plant population. For example, a rate at which the plants respond differently to each other from the single environmental microclimate parameter variable being altered may provide evidence or a lack of evidence in determining specific genotype by environmental responses. Moreover, the rate may also optimize both growth and value add stages in respect to every environmental microclimate parameter for each point in time throughout a life cycle of the plant. Comparing this phenotypic data, the abiotic inputs used to create it, and/or the genetic information available about the specific variety, the microclimate treatment parameters may be applied to a production unit of the chamber 100, at commercial volumes and/or for personal home-production.

The growth chamber 100 may be used for research and/or production of plants, in this aspect cannabis plants, whereby each plant may be grown in with an individually-uniform abiotic treatment within the chamber 100. An environmental microclimate 5 within the growth chamber 100 may include an environmental microclimate treatment application and a plant associated with the environmental microclimate 5 with the growth chamber 100. A position of each plant within the chamber 100 may be spatially oriented with equal distance from adjacent plants within the chamber 100. An environmental area 5 of each plant may generally correspond to each abiotic treatment application apparatus delivery point. Because the abiotic environment within the chamber 100 may be altered by the plants and the abiotic treatment apparatuses, having these two components (e.g. environmental influence from the expression of neighboring plants and the environmental influence from the treatment apparatuses) arranged around each plant in the same orientation offers each plant an individually-uniform abiotic treatment within the chamber 100.

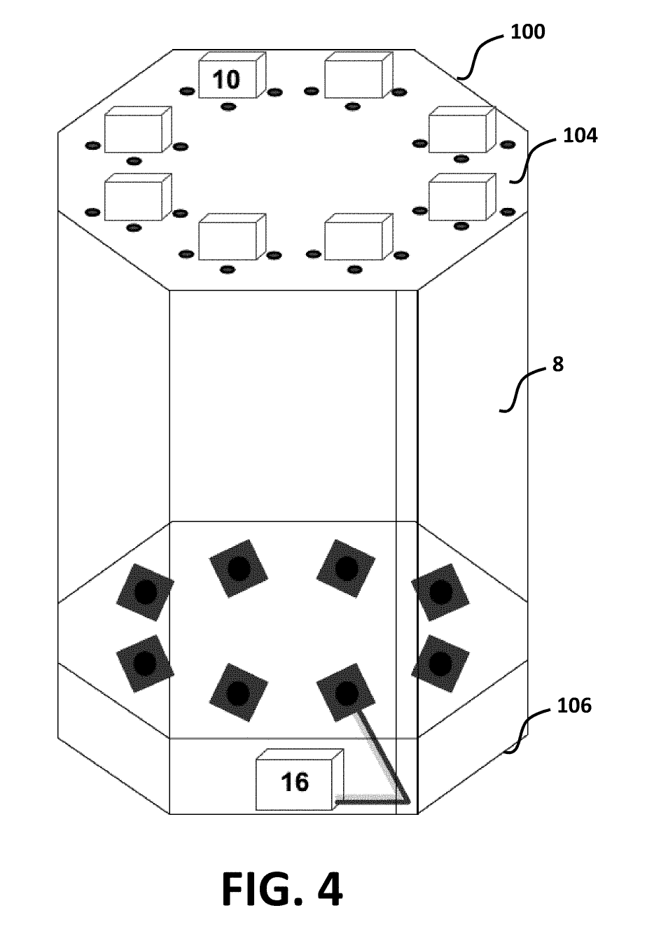

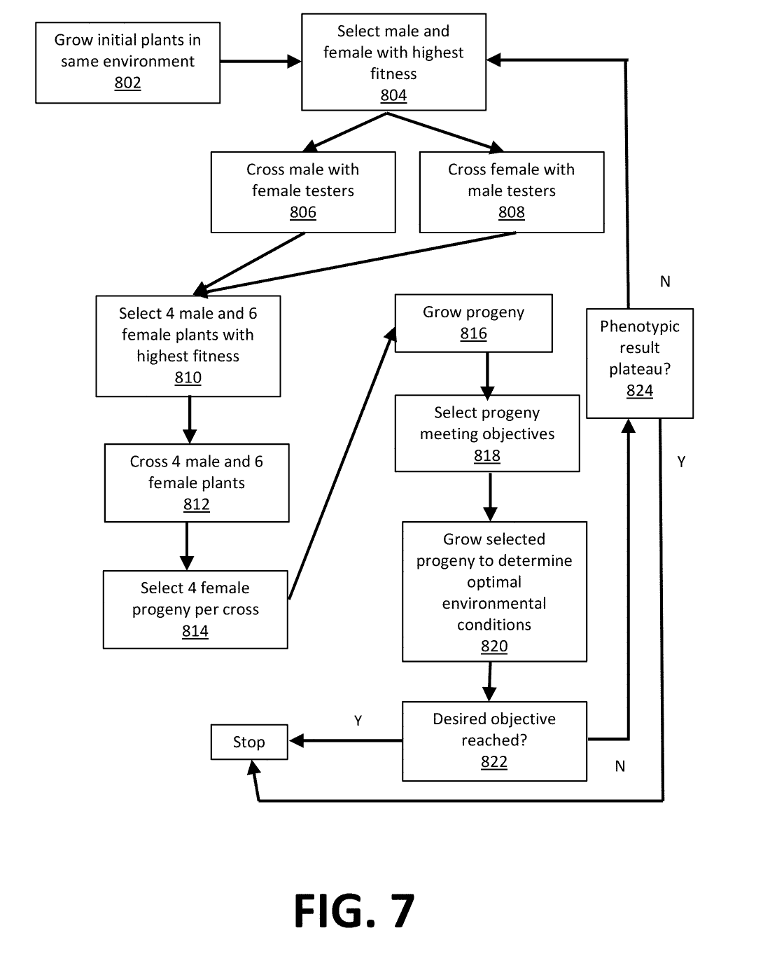

As shown more clearly in FIG. 4, the chamber 100 may comprise a vertical octagonal prism with a floor 106 and a ceiling 104 shaped as octagons and a plurality of walls 8 shaped as rectangles. The exterior walls 8 of the chamber 100 may stand on a periphery of the floor 106 and ceiling 104. These exterior walls 8 may house one or more exterior access doors (not shown) to the chamber 100. In some aspects, one edge of the exterior wall 8 may be coupled to the floor 106 and ceiling 104 using one or more hinges 6 extending there between in order to facilitate the entire exterior wall 8 swing outward from the chamber 100. A latch or other fastening method may be on the edge of the exterior wall 8 opposite the hinge edge 6 in order to hold the wall 8 closed. A perimeter of the exterior wall 8 may comprise a sealing member to isolate an internal environment of the chamber 100 from an external environment. The inside of the chamber 100 may have an environment floor 27, shown more clearly in FIG. 7 for holding soil or other soil-like material.

Turning now to FIGS. 1 to 3, the chamber 100 may comprise a central hub 108 having a vertical support 7. The central hub 108 may have a plurality of post-like structural components (not shown) around the central hub 108 of the chamber 100. The central hub 108 may form a smaller octagonal prism shaped arrangement thereby forming a plurality of interior walls 9 of the chamber 100.

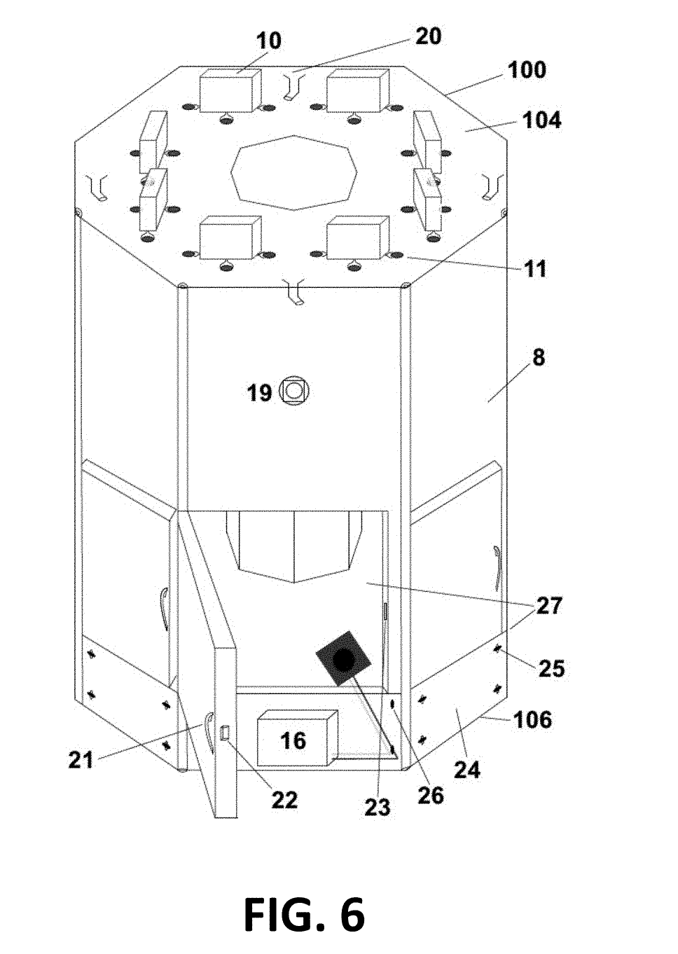

The exterior walls 8 and/or interior walls 9 may further have one or more access doors facilitating access to system components (e.g. lights, sensors, air ducts, plumbing) located behind their respective wall 8, 9. For example, FIG. 6 demonstrates a lower chamber panel cover 24 having a panel latch 25, 26 for securing the chamber panel cover 24. The lower chamber may house the water/nutrient reservoir 16 as described further below. Also shown in FIG. 7, an upper chamber access door 21 may have door handle and latch 22 and a latch receiver 23. The exterior walls 8 and/or interior walls 9 may possess an environmental microclimate treatment apparatus delivery points capable of creating corresponding environmental microclimates homologous to each plant within the chamber 100.

The chamber 100 may comprise one or more sensors for each environmental area 5. The sensors may measure air temperature, humidity, carbon dioxide (CO₂), pH, electrical conductivity, water temperature, water oxygen (O₂), water level, and/or light intensity. The sensors may also comprise visible light cameras, fluorescence cameras, infrared cameras, and/or 3D or stereoscopic imaging cameras as described above.

Each environmental area 5 may vary a number of factors composing the environment for the respective plant. The factors may include one or more categories of air, light, soil, and/or water. The air factors may comprise composition, velocity, and/or direction. The light factors may comprise wavelength, intensity, and/or direction. The water factors may comprise nutrient composition, nutrient concentration, water availability, water consistency, flow rate, and/or O₂ level. Soil composition or soil substitute composition may provide information about an individual plant. For example, different levels of compaction, cation exchange capacity (e.g. hold onto nutrients), and/or drainage may influence growth rates. Testing may be done to determine root characteristics among varieties in order to assess drought resistance and/or compaction resistance.

The lighting apparatus, shown more clearly in FIG. 1, may comprise ceiling lights 1 on the ceiling 104 of the chamber 100, exterior lights 2 on the interior side of the exterior walls 8, and/or central lights 3 on the exterior of the central hub 108. In some aspects, there may be floor lights (not shown) on the floor 106 of the chamber 100 located around each plant and/or angled towards the plant. In this aspect, each of the lights 1, 2, 3, may comprises one or more light emitting diodes (LED), but may comprise other light types such as incandescent, infrared, ultraviolet, etc. In this aspect, LEDs may be used due to low emission levels of heat and/or ability to control a spectrum of light provided to the chamber 100 in order to optimize the environment.

In the present aspect, the lighting apparatus comprises eight ceiling lights 1, sixteen exterior lights 2, and eight central lights 3. In other aspects, the number of lights may be varied depending on the number of environmental areas 5 within the chamber 100. In some aspects, the entire surface of the ceiling 104, the interior side of the exterior walls 8, and/or the exterior of the central hub 108 may comprise LEDs so as to form a generally continuous light surface.

A patch panel 17 may be connected to a controller (not shown) executing instructions from a tangible computer-readable medium (not shown) in order to vary one or more individually controllable lighting parameters, such as photoperiod, intensity, frequency or colour, etc., for each of the environmental areas 5. Each of the ceiling lights 1 may be individually controllable; each of the exterior lights 1 may be individually controllable; and each of the central lights 3 may be individually controllable. In some aspects, each individual LED may have one or more individually controllable lighting parameters (e.g. intensity, frequency (colour), etc.) permitting very precise adjustment of lighting within the environmental zone 5. In some aspects, the direction of light may be homogenized. According to some aspects, the chamber 100 may have two or more lighting channels (e.g. eight) when constructed for a research purpose while the chamber 100 may be only one lighting channel when constructed for a production purpose. The lights 1, 2, 3 may be supplied power by wiring 4 from the patch panel 17 according to the instructions executed by the controller.

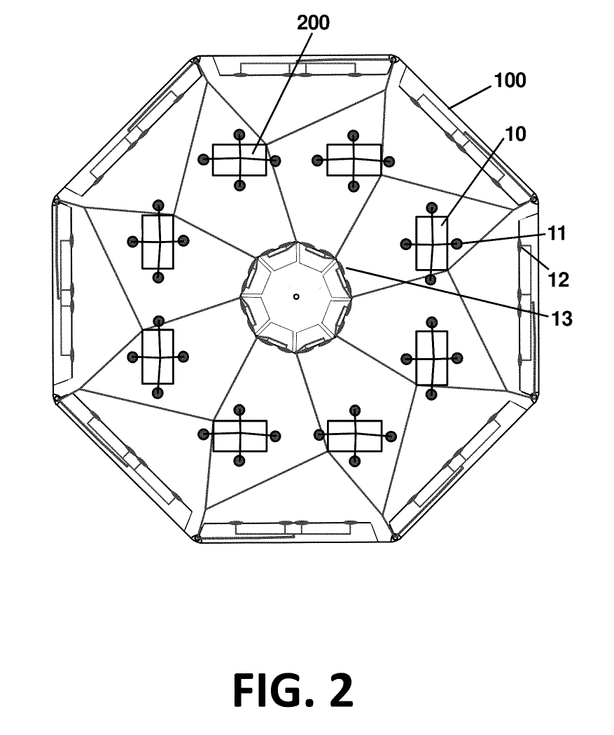

Within the chamber 100, one or more environmental microclimate air treatment application apparatuses 200, shown more clearly in FIG. 2, may be located in a radially symmetric arrangement from the central hub 108 of the chamber 100. A plurality of HVAC systems 10, such as a packaged dx system, may provide treated air to each environmental area 5 the interior of the chamber 100. Each HVAC system 10 may withdraw air from the interior of the chamber 100 by way of one or more air outputs 11 located in the ceiling 104. Each HVAC system 10 may provide treated air to the interior of the chamber using one or more air inputs 12, 13. The air inputs 12, 13 may be located on the interior side of the exterior walls 8 and/or the exterior side of the central hub 108. In some aspects, there may be floor air inputs and/or outputs (not shown) provided on the floor 106 of the chamber 100. Each HVAC system 10 may comprise a heater, a fan, humidifier, dehumidifier, and/or an air conditioner.

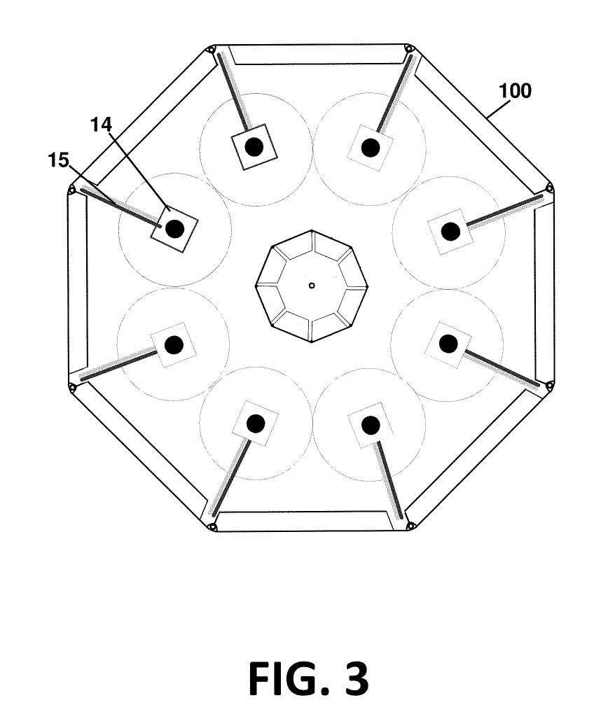

The air supply inputs 12, 13 may direct treated air of the environmental microclimate 5 to opposing sides of every plant in the chamber 100 as shown in more detail in FIGS. 3 and 4. The air supply inputs 12, 13 may vary the treatment in air stream velocity, air stream width, and/or air stream composition. The air treatment component of the environmental microclimate 5 may be removed through air outtakes 11 arranged above each of the plants in the ceiling of the chamber 100 bringing the removed air component of the environmental microclimate 5 to the air treatment control box 10 where the air may be adjusted back to the set control and returned to the corresponding air supply inputs 12, 13 within the chamber 100. An air velocity for each microclimate 5 may exist in the chamber 100 in a declining gradient the further away from the delivery points 12, 13. Unlike humidity, neighboring plants may not contribute to the air velocity within the chamber 100.

Turning now to FIGS. 3 and 4, a water treatment control unit 16 may condition the water provided to each environmental microclimate 5. One or more hydroponic systems 16 may provide treated water to the roots of one or more plants within the chamber 100 driven by a pump (not shown) from a reservoir (not shown) located within the bottom section of the growth chamber 100.

In this aspect, there may be a water treatment control unit 16 for each environmental microclimate 5. In other aspects, there may be only one water treatment control unit 16 that adjusts one or more water treatment parameters and supplies each environmental microclimate 5 through the use of a plurality of valves (not shown). The roots of the plant may be incorporated within a substrate container 14. The substrate container 14 may be supplied with treated water using input lines 15 from a treatment pump within the water treatment control unit 16. The water may also be drained using output lines 15 from the substrate container 14.

A combination of the HVAC system 10 and the water treatment control unit 16 may alter a humidity parameter for each microclimate 5. For example, if the humidity parameter is changed in a uniform population of plants, a realized humidity around each plant within the microclimate 5 may exist as a range corresponding to the humidity generated by the HVAC system 10 and the amount of water provided by the water treatment control unit 16.

A method of using the chamber 100 may involve delivering multiple environmental microclimate treatments allowing the application of abiotic gradients. Each environmental microclimate may provide a controlled range to be applied for a single variable creating a clear relationship between the environmental microclimate 5 and a response of the plant. The phenotypic response may be measured through growth and information involving the relationship between genetics and the environment. By iteratively growing homogeneous plants, the parameters may be optimized. The optimization of the growing parameters within a chamber 100 may be the best abiotic environment treatment across the life span of all plants within a chamber 100, to achieve the highest realization of a phenotypic objective using the least energy necessary. In some aspects, the chamber 100 may additionally comprise an energy meter (not shown) that receives an energy consumption measurements from each of the subsystems of the chamber 100. The energy consumption measurements may then be used in the optimization. For all cloned plants within a chamber 100 to be grown under optimized conditions, each plant must be grown under a uniform environmental microclimate treatment.

According to some aspects, once a set of optimal parameters has been determined, further iterations may be conducted using the chamber 100 to determine an optimal range for each of the parameters in order to determine outer limits for their respective parameters. For each iteration, the parameters may be stored in a database of plants. Therefore, with increasing numbers of iterations, more data for the particular plant may be gathered on the phenotypic response along a specific abiotic gradient. This data may provide understanding of one or more mechanisms involving an activation and a deactivation of gene expression unique to different varieties of plants. Subsequent research on new varieties may allow data to be compared to determine differences in the genome of the plants and how those differences relate to differences in phenotypic response of the plant. As new varieties of plants continue to be researched, the data may be used to predict how a plant may respond based on its particular genetics. This data may also be used to breed new varieties that offer a greater objective potential for a particular climate.

Methods, apparatuses, and system for growing plants may involve various logical and physical subsystems communicating sensor information throughout the plant lifecycle to a database stored on a secure datacenter. This datacenter may support genetic, environmental, and/or phenotypic data for each growth trial. Growing cannabis plants from clonal propagation or genetically identical F1 hybrid seed may ensure homogeneity in genetic material for all plants within the growth chamber 100. With a population of genetically homogenous cannabis plants, an end-product may solely be influenced by the application of environment from the chamber 100.

According to some aspects, an artificial intelligence (AI) method may be used in determining an optimal environment to achieve any set objective for a specific genotype for all stages of development. The AI method may associate levels of fitness of the plants to different environments according to the plant's ability to represent a set objective. These levels of fitness may be used in the AI algorithm to determine a next generation of trials based on a growing intelligence of how that genotype responds. The levels of fitness may be determined by how much a trial represents a desired outcome. An example relating to cannabidiol (CBD) production is described below. One of skill in the art would know how to apply these techniques to other plant types.

If a breeding program may optimize a CBD production of a genotype, then a list of all the phenotypic parameters pertinent to the CBD production may be made. A threshold for each of the phenotypic parameters such as terpene content, rate of growth, total biomass produced, etc. may be set in the AI method depending on the researcher's criteria. The design of these trials may vary but, in this example, the objective of optimizing the phenotypic parameter of CBD content while maintaining all other desired phenotypic parameters above a certain threshold is the focus. Each generation of plants may be tested for CBD content and if the plant meets all other parameters this CBD content level may denote the fitness of this environment and the likelihood of being selected in a next generation from the original set of environments. There may be x number of varieties that meet the phenotypic parameters and their CBD content may be graphed between 0 and 1 to determine fitness with 1 being a higher producing CBD content and 0 being a lower producing CBD content. A selection of plants that demonstrated a fitness of over 0.8 (or just increase likelihood) may move to the next mating pool. Because trials are repeatable, growing the same genotype in the same environment more than once is unnecessary. For this reason, all new generations may be developed by crossing two parent environments. The likelihood of a choosing a parent environment may be reliant on their fitness. A set of random combinations may be based on the ability to meet the set objectives.

To encode environments, variable parameters may be associated with specific coefficients to indicate treatment. For example, variables may be: A—Light Spectrum, B—Light Intensity, C—Air Velocity, D—Air Temperature, and/or E—CO₂ and have the stages: V—Vegetative and R—Reproductive.

To determine a set of environmental parameter benchmarks, initial gradient trials with 7 trials and 1 buffer may be grown to collect an initial set of response curves to determine benchmarks for subsequent trials. The researcher may determine benchmarks as for example, a range of light to achieve a threshold result with varying different temperature or humidity.

Determination of a normal production environment may represent a maximum of 1 for each of the variables. Subsequent numbers may arbitrarily represent variable parameters. For example, a specific environment may be called “AV1 AR1 BV1 BR1 CV1 CR1 DV1 DR1 EV1 ER1”. The benchmark trials may unveil a more specific range of likely parameters to test, subsequent trials may look as such:

“AV2 AR1 BV1 BR1 CV1 CR1 DV1 DR1 EV1 ER1”
“AV3 AR1 BV1 BR1 CV1 CR1 DV1 DR1 EV1 ER1”
“AV4 AR1 BV1 BR1 CV1 CR1 DV1 DR1 EV1 ER1”
“AV2 AR2 BV1 BR1 CV1 CR1 DV1 DR1 EV1 ER1”
“AV2 AR3 BV1 BR1 CV1 CR1 DV1 DR1 EV1 ER1”
“AV2 AR4 BV1 BR1 CV1 CR1 DV1 DR1 EV1 ER1”
“AV1 AR1 BV2 BR1 CV1 CR1 DV1 DR1 EV1 ER1”
“AV1 AR1 BV3 BR1 CV1 CR1 DV1 DR1 EV1 ER1”
“AV1 AR1 BV4 BR1 CV1 CR1 DV1 DR1 EV1 ER1”
“AV1 AR1 BV1 BR2 CV1 CR1 DV1 DR1 EV1 ER1”
“AV1 AR1 BV1 BR3 CV1 CR1 DV1 DR1 EV1 ER1”
“AV1 AR1 BV1 BR4 CV1 CR1 DV1 DR1 EV1 ER1”

While dependent on the resources available, the researcher may perform many of these trials to achieve a widest range of environmental data to have determine an optimization. The environments that surpass the threshold(s) may be added back into the population.

As previously stated, there is no point in re-growing a trial except for calibration so once a trial has been grown, the trial may only be selected as one of the two parents of a subsequent trial. The fitness of the environment may dictate the likelihood of being selected as one of the two parents. When two parents are selected, the values of each of their parameters may be met in the middle. If this improves the response, this environment may have a higher fitness than both parents. In this way, the AI method may be used to make advancements toward achieving any set objective. The complexity in relationship between genotype and phenotype in cannabis makes this an attractive model for improving production capabilities in any aspect.

Alternatively, the chamber may provide uniformly identical environments, growing separate varieties under a single environment modeled after a specific climate may look very similar to this method. The difference may be instead of comparing a population of environments to each other determining a best one to achieve an objective, compare populations of genotypes may be compared to determine the most suitable genotype for that environment. Subsequent trials may then cross the parents (rather than add and split variable parameters as for the environment example).

For example, a breeding program layout 800, shown in FIG. 7, for a 98 chamber system may be performed. Cycle 2 tests General Combining Ability (e.g. Additive Gene Action). Cycle 1 may grow 768 individual plants with varying genetics in the same environment (step 802). A selection may be made of 192 male and 192 female plants with a highest recorded fitness (step 804).

In cycle 2, the 192 selected male plants may be crossed with 2 female testers selected from the 192 selected female plants (step 806). Each tester may be the same variety in order to measure the General Combining Ability (GCA). The 192 selected female plants may be crossed with 2 male testers selected from the 192 selected male plants (step 808). Again, each tester may be the same variety in order to measure the GCA. A selection may be made at step 810 of 4 male plants and 6 female plants with the highest fitness.

At cycle 3, the 4 male plants and 6 female plants may be crossed to produce 24 crosses (step 812). At step 814, the female seeds may be determined and 4 female progeny per cross may be selected.

At cycle 4, grow progeny and grow 8 of each of the 96 genotypes in each chamber in 4 standard environmental treatments designed to unveil environment x genotype action (step 816) using high vegetative stress, low vegetative stress, high reproductive stress, and low reproductive stress. At step 818, select the plants with the genotype meeting the desired objectives.

At cycle 5, (step 820) grow 672 plant treatments (96×7) in 96 chambers to determine optimized environmental conditions to achieve the desired objectives. For example, cycle 5 may grow 12 lighting treatments across 8 standard environments.

At cycle 6, (step 822) depending on the results of cycle 5, continue to exchange treatments (returns to step 804) in a matter that may increase the probability of improved environments being selected for the next trial generation at a higher rate than environments that are less representative of the desired objectives (e.g. lower fitness). Continue until desired phenotypic results plateau or the desired objectives are reached (step 824).

According to some aspects, a set of optimal parameters may be used to determine an optimal location and/or optimal climate suitable for a plant type. Plant seeds may then be packaged with the associated optimal parameters and marketed to the optimal location and/or climate. In other aspects, a commercial production facility may be constructed using the set of optimal parameters.

In other aspects, a home-based chamber 100 may be use for personal production of the plants. As one or more microclimate 5 may be delivered, the chamber 100 may be used to offset a growing cycle for each plant. Through offsetting the growth cycle, a harvest date may be different for each plant permitting a constant supply of the plant (and an active ingredient) for consumption. For example, two plants may be grown at a first date and two other plants may be grown at a second date, the second date being later than the first date. As a result, the harvest date will be later for the second set of plants.

In other aspects, the chamber 100 may have optimal parameters in one of the microclimates 5 to maximize a particular active ingredient for one of the plants, and have less optimal parameters in another microclimate 5 to produce a weaker amount of the particular active ingredient. This use of more than one environmental microclimate 5 may be used to express the phenotypic plasticity of a single variety to produce multiple end products from the same genetic material.

The use of more than one environmental microclimate 5 may also be used to grow more than one variety at a time within a chamber 100. Because of the range of maturation dates between varieties, this may cause an offset harvest for cannabis plants within the chamber 100.

In some aspects, a commercial production chamber 100 may involve a similar structure to the growth chamber 100. The product chamber 100 may further comprise HVAC, lighting, and/or water systems optimized for predetermined, optimized parameters.

Phenotypic image data may be collected throughout the life cycle of the plants within the chamber 100 from various sensors as previously described above. This data may be directed to an integrated analysis platform (IAP) where block-based methods may be used to analyze each dataset specifically correlating collected image and sensor data with measurable phenotypic traits which may then be indexed for plant fitness and compared across plants. Automated high-throughput image collection using RBG, 3D, Infrared, and/or Fluorescence cameras along with manually collected hyperspectral imaging may be interpreted using the IAP.

Abiotic sensors may be present within the chamber 100 to control the treatment delivery apparatus in response to current environmental conditions. These abiotic sensors may guide a rate/application of the relative treatment delivery apparatuses to maintain an accurate and/or consistent parameters of the treatment environment throughout the growth cycle. Significant levels of the treatment environment represented within the chamber may be determined through a calculation of accuracy confidence of the sensors and through regular calibration of sensors.

For example, the air treatment apparatus 200 is provided. When air is cycled into the air treatment apparatus, sensors within the air treatment apparatus may detect pre-treated levels of CO₂, humidity, and/or temperature. Each aspect may be treated in a similar routine involving a pretreatment measurement, treatment application, pre application (e.g. treatment that has been created but not applied to the chamber 100), and/or ambient sensing within the chamber 100 to ensure homogenous application. Because aspects of the air treatment may be dependent on each other (e.g. higher temperature air holds more humidity, etc.), the air treatment apparatus 200 may first measure all parameters, then add/apply treatments, next the air may be sensed for all parameters and any necessary changes to the application may be made and reapplied.

Ambient sensors may also be used at the specified locations within the chamber 100. The ambient sensors may be used to initially calibrate the treatment apparatus controls corresponding to the environmental control they deliver. For example, the overhead light may be calibrated to 45% power in order so the delivered light intensity of photosynthetic photon flux density (PPFD) of x mol/m²/s at a particular distance and/or angle. This calibration may be performed prior to the plants being placed within the chamber 100.

The calibration of some aspects may require waiting at least in part until the plants are in the chamber 100. For example, air velocity may need to be calibrated once the plants are in the chamber 100 as the plants may disrupt the air velocity within the microclimate. In another example, the plant may alter the humidity treatment environment. Because of the plants effect on the microclimate, the controls may be calibrated during the cycle and/or delivering air at velocity x at the beginning of the treatment may not mean that at the end of the treatment velocity x may be producing the same microclimate. If air velocity x resulted in 1 meter/sec air movement across a leaf surface when the plant is 18 inches tall, the air velocity may be different for a different plant size. For example, the air velocity may be 0.5 meter/sec air movement across the leaf surface when the plant is 36 inches tall and in its reproductive phase. Tactical configuration using infrared cameras to measure the nature of transpiration may allow the chamber 100 to maintain a treatment environment throughout the stages of plant growth.

In some aspects, the sensors housed internally within the air treatment and delivery apparatus 200 may be used with the following actuators: air cooler, air heater, humidifier, dehumidifier, CO₂ solenoid, and/or airflow supply/return fan.

Treatments may include, but are not limited to, using the parameters that have been described. In other aspects, other sets of treatments may include the application of organisms intended to express biological symbiosis with the research plant such as mycorrhizal symbiosis.

These examples outlined herein may vary the relationship that environmental microclimate parameters may have between the application from the environmental microclimate apparatus and the neighboring plants within the chamber 100. There may be two scenarios in which the influence of neighboring microclimates may need to be taken into consideration. First, when a gradient of a single variable may be created along a chamber, 7 out of 8 plants may receive the range of the gradient with the 8th plant acting as a buffer, receiving treatment 1 on half of the plant and treatment 7 on the other half. The 8^{th} plant may be receiving both extremes of the gradient and providing a buffer area between samples for data collection. The second scenario may exist when treatment environments delivered within a chamber contain microclimates differing by more than one variable. In this situation 4 out of 8 plants (e.g. every other plant) may receive microclimate treatments intended for data collection while the other 4 plants may act as buffers receiving a combination of the two adjacent treatment microclimates.

Although the aspects described herein are particular to cannabis plants, the aspects may be equally applied to opium poppies, tobacco, deadly nightshade, rhubarb, cascara, Alexandian senna, foxglove, lily of the valley, pomegranate, rose, lavender, thyme, etc. The aspects described herein may equally apply to recombinant pharmaceutical proteins in crops like Nicotiana benthamiana and/or Oryza sativa. Although only particular plant types have been described herein, the techniques and chamber 100 may equally apply to any plant with enough economic potential in order to motivate experimentation. For example, medicinal plants with specific compound potential may be grown in chambers 100. The microclimate may also facilitate mimicking any range of climatic conditions for breeding crops in uniformly identical environments to have every phenotypic difference result as a difference in genotype and not from different environments.

The foregoing is considered as illustrative only of the principles of the invention. Further, since numerous changes and modifications will readily occur to those skilled in the art, it is not desired to limit the invention to the exact construction and operation shown and described, and accordingly, all such suitable changes or modifications in structure or operation which may be resorted to are intended to fall within the scope of the claimed invention. Although the aspects described herein may have been described individually, any and/or all of the aspects may be combined with their particular advantages and/or features.

What is claimed is:

1. A plant growth chamber comprising:
a hub;
an exterior wall encompassing the hub;
a ceiling and a floor extending between the exterior wall and the hub;
at least one microclimate between the exterior wall and the hub; and
at least one sensor configured to measure at least one parameter from the at least one microclimate or a plant within the at least one microclimate in order to maintain at least one abiotic gradient associated with the at least one microclimate.

2. The plant growth chamber according to claim 1, further comprising a controller executing instructions from a tangible computer-readable medium to control at least one of: a hydroponic system, a lighting system, a nutrient system, and an HVAC system.

3. The plant growth chamber according to claim 2, wherein the controller executes instructions to maintain the at least one abiotic gradient associated with each of the at least one microclimate based on a measurement data from the at least one sensor.

4. The plant growth chamber according to claim 2, wherein the hydroponic system provides moisture to at least one root of the plant.

5. The plant growth chamber according to claim 4, wherein the hydroponic system provides nutrients to the at least one root of the plant.

6. The plant growth chamber according to claim 4, wherein the hydroponic system comprises a substrate container; an input line receiving moisture from a treatment pump; and a water treatment controller controlling the treatment pump.

7. The plant growth chamber according to claim 2, wherein the lighting system comprises at least one light associated with each of the at least one microclimate; and each of the at least one light being individually controllable.

8. The plant growth chamber according to claim 7, wherein the at least one light having a controllable photoperiod with an intensity and a frequency.

9. The plant growth chamber according to claim 8, wherein the at least one light is located above the at least one microclimate.

10. The plant growth chamber according to claim 2, wherein the HVAC system comprises at least one of: a heater, a fan, a humidifier, a dehumidifier, and an air conditioner for treating air provided to at least one air supply input associated with the at least one microclimate.

11. The plant growth chamber according to claim 10, wherein the HVAC system comprises directing the treated air to adjust at least one of: an air velocity, an air stream width, and an air stream composition.

12. The plant growth chamber according to claim 10, wherein the HVAC system further comprises at least one air outtake arranged above each of the at least one microclimates.

13. The plant growth chamber according to claim 1, wherein the at least one microclimate is equally spaced from adjacent microclimates.

14. The plant growth chamber according to claim 1, wherein the exterior wall comprises at least one door for accessing the at least one controlled microclimate.

15. The plant growth chamber according to claim 1, wherein the at least one sensor comprises a non-destructive sensor.

16. The plant growth chamber according to claim 15, wherein the non-destructive sensor is selected from at least one of: at least one air temperature sensor, at least one humidity sensor, at least one pH sensor, at least one electrical conductivity sensor, at least one water temperature sensor, at least one carbon dioxide sensor, at least one water level sensor, and at least one light intensity sensor.

17. The plant growth chamber according to claim 15, wherein the at least one sensor is at least one camera.

18. The plant growth chamber according to claim 17, wherein the at least one camera comprises at least one of: a colour camera, an infrared camera, a fluorescence camera, and a hyperspectral camera.

19. A method of growing plants, the method comprises:
providing a plurality of plants within an enclosed growth chamber;
controlling at least one microclimate within the enclosed growth chamber to create an individually-uniform environmental microclimate for every plant within the chamber; and
automatically recording at least one parameter of the at least one microclimate associated with a morphology of the plurality of plants.

20. The method according to claim 19, the method further comprises:
adjusting the at least one microclimate;
determining at least one optimal parameter for the at least one parameter to produce a response curve for each of the at least one microclimate; and
establish suggestions to improve a conditions of the plants within the enclosed growth chamber.
